(19) United States
(12) Patent Application Publication
(10) Pub. No.: US 2015/0079299 A1
(43) Pub. Date: Mar. 19, 2015

(54) AEROSOL COATING PROCESS BASED ON VOLATILE, NON-FLAMMABLE SOLVENTS

(71) Applicants: THE REGENTS OF THE UNIVERSITY OF CALIFORNIA, Oakland, CA (US); LAWRENCE LIVERMORE NATIONAL SECURITY, LLC, Livermore, CA (US)

(72) Inventors: Herbert B. Scher, Moraga, CA (US); Durham K. Giles, Davis, CA (US); Joseph W. Tringe, Walnut Creek, CA (US); Harold W. Levie, Livermore, CA (US)

(73) Assignees: LAWRENCE LIVERMORE NATIONAL SECURITY, LLC, Livermore, CA (US); THE REGENTS OF THE UNIVERSITY OF CALIFORNIA, Oakland, CA (US)

(21) Appl. No.: 14/490,977

(22) Filed: Sep. 19, 2014

Related U.S. Application Data
(63) Continuation of application No. PCT/US2013/031033, filed on Mar. 13, 2013.
(60) Provisional application No. 61/615,714, filed on Mar. 26, 2012.

(51) Int. Cl. A01C 1/06; B05D 1/12; B05D 1/02

(52) U.S. Cl. CPC A01C 1/06; B05D 1/02; B05D 1/12
USPC 427/427.4; 427/421.1

(57) ABSTRACT

A method for coating target surfaces by spraying an atomized liquid formulation of a volatile solvent, a dispersant, and adhesion promoter, a polymer, a plasticizer and particulates of an active material and vaporizing the solvent from the spray droplets to form deformable solid particles in flight that impact the target surface to form a coating. The temperature of the atomizing gas used to form the spray and the liquid formulation temperatures can be manipulated to accelerate or decelerate the evaporation of solvent and balance the heat of vaporization of the solvent in the spray liquid so that condensation of ambient vapors in the atmosphere surrounding the deposition target is prevented.

### CROSS-REFERENCE TO RELATED APPLICATIONS

This application is a 35 U.S.C. §111(a) continuation of PCT international application number PCT/US2013/031033 filed on Mar. 13, 2013, incorporated herein by reference in its entirety, which claims priority to, and the benefit of, U.S. provisional patent application Ser. No. 61/615,714 filed on Mar. 26, 2012, incorporated herein by reference in its entirety. Priority is claimed to each of the foregoing applications.

The above-referenced PCT international application was published as PCT International Publication No. WO 2013/148213 on Oct. 3, 2013, which publication is incorporated herein by reference in its entirety.

### STATEMENT REGARDING FEDERALLY SPONSORED RESEARCH OR DEVELOPMENT

This invention was made with Government support under DE-AC52-07NA27344 awarded by the U.S. Department of Energy (DOE). The Government has certain rights in the invention.

### INCORPORATION-BY-REFERENCE OF COMPUTER PROGRAM APPENDIX

Not Applicable

### BACKGROUND OF THE INVENTION

1. Field of Invention

This invention pertains to the material coating methods and systems and more particularly to the synthesis and use of formulations of dispersants, adhesion promoters, polymers, plasticizers and active materials dissolved or dispersed in a non-flammable, low boiling point solvent such as methylene chloride that is delivered with an aerosol process to target surfaces.

2. Background

Coating seeds with fungicides and insecticides has become a major component of the agricultural seed producing industry. In the case of high value agricultural seeds, coating is often the critical final production step. The driving force behind the rise of such seed treatments is the need to protect high value genetically modified grain and vegetable seeds from soil borne diseases. Other advantages of seed treatments include accurate dosing and placement of pesticide as well as the cost savings associated with applying seed and pesticide in the same pass. Functional coatings can also improve seed handling and appearance, alter surface properties and provide protection from mechanical abrasion. Furthermore, coatings can be designed to achieve specific permeability to water and pesticides, assuring timely seed germination and enabling effective control over the release of pesticide into the soil.

Seeds are currently treated with pesticides in mixing chambers utilizing dusts or aqueous based slurries containing polymers to improve adhesion. Dust treatments have lost popularity due to worker exposure concerns and poor seed adhesion properties. Aqueous based slurry treatments often have problems associated with nonuniform pesticide coverage, lengthy drying times and sticky coatings which require post treatment with fine particle lubricants such as talc. However, talc dust used in neonicotinoid insecticide seed treatment has been recently implicated in causing bee toxicity as a result of its dislodgement from seed during planting operations.

Liquid coating technology is often used to coat solid product forms. A mixture of polymers, pigments and other excipients are dissolved or dispersed in water or organic solvents and sprayed onto the solid forms that are then dried with continuous exposure to heat. Rotary pan coaters are used for the larger product forms such as tablets and fluidized bed coaters are used for smaller sized product forms. One disadvantage of liquid coating technology is the necessary use of flammable solvents, the most common being ethanol, isopropanol or acetone, that require the use of explosion-proof equipment.

In order to overcome the limitations of aqueous coating technology, new efforts have been made in recent years to develop solventless (powder) coating technology. There are generally four powder coating techniques based on the use of a rotary pan coater that are currently in use. While these dry coating techniques overcome some of the disadvantages of liquid coating technology, other limitations present themselves.

One approach is the plasticizer dry coating technique where powder polymer particles are sprayed onto the product surface simultaneously with liquid plasticizer sprayed from a separate spraying nozzle. The sprayed liquid plasticizer wets the powder particles and the product surface, promoting the adhesion of particles to product surfaces. The coated products are then cured above the film forming temperature to form a continuous film. The plasticizer lowers the film forming temperature requiring additional heat to form a film.

However, a plasticizer/polymer ratio of 1/1 is normally required for the adhesion of enough particles to the product surface in order to get a coating that is thick enough for sufficient protection or proper controlled release. This high plasticizer level leads to soft or sticky films. It is often difficult to adjust the plasticizer level to get sufficient coat thickness and at the same time produce a dry coating.

Another approach is the electrostatic dry coating approach based on the attraction of charged sprayed polymer powder particles to grounded product forms. The product forms are then heated to fuse the particles to produce a continuous coating. However, the electrostatic attraction between the charged polymer particles and the solid dosages with low conductivity or high electric resistance is typically weak, leading to difficulty in producing a thick coat. This process requires heating after deposition and can be challenging when the surface to be coated is complex. Moreover, often the surface to be coated must remain stationary during coating due to the requirement that it must remain electrically neutral, even as charged particles are depositing on it; therefore, it must be actively grounded through continuous physical contact.

A further approach is heated dry coatings. Polymer powder particles are fed into a rotating bed containing the product forms. An infrared heat source mounted above the bed to provide heat to melt the polymer particles that first adhere to the product forms and then fuse to form a coating around the product forms. It is a challenge using only heat to adhere polymer particles to the product forms to achieve smooth, uniform and thick coatings.

Another approach is the plasticizer-electrostatic-heat dry coating technique that combines the electrostatic spraying of polymer powder and plasticizer onto the product form with heating to fuse the plasticized polymer powder to form a coating. This technique has the limitations of the plasticizer dry coating and electrostatic dry coating approaches with the additional complication of trying to balance the use of plasticizer, electrostatics and heat to achieve an optimum result.

These coating techniques that have been described are also used on materials other than seeds. For example, pharmaceutical solid dosage forms include tablets, granules, beads, powders and crystals. These solid dosage forms are often coated to mask odor or taste as well as provide protection from water, light, a gastric environment or air. Coatings may also provide enhanced mechanical strength to prevent attrition, control the release of active ingredients with a polymeric barrier or permit the application of pigments to the surface for improved aesthetics.

Accordingly, there is a need for a coating system that has the advantages of the aqueous coating system and powder coating systems but eliminates almost all of the limitations of those systems. There is also a need to economically provide a coating material that is stable, durable, and can be consistently applied on a large scale. The present invention satisfies these needs as well as others and is generally an improvement over the art.

### SUMMARY OF THE INVENTION

Generally, the present invention is a volatile solvent coating system. By way of example, and not of limitation, the volatile solvent coating system is a hybrid system that retains the advantages of the liquid coating systems and powder coating systems but eliminates almost all of the limitations of those systems. In one embodiment, the methods of the present invention comprises simultaneously dissolving coating chemicals and adhesion promotion agents in a non-flammable, low boiling point solvent such as methylene chloride; and delivering the liquid through a gas atomization nozzle and transformative process to the target surfaces.

Because of the volatility of the solvent, the process can be tuned to allow only a trace of the solvent to arrive at target surfaces concurrently with the coating chemicals and adhesion promotion agents. By altering the elapsed time period between atomization and emission of the droplets and their subsequent impact on the target, the amount of solvent remaining, the physical properties of the in-flight droplets/particles can be controlled. Alternatively, the relative temperature between the droplets and the ambient or atomizing gas can be tuned to control the rate of solvent vaporization. Combinations of flight times and relative temperatures can be manipulated to achieve the desired degree of solvent vaporization and particle properties.

In the preferred embodiment, the present invention comprises spraying a liquid containing a polymer, particulates, active ingredients and protective agent's components dissolved/dispersed in a highly volatile, nonflammable organic solvent and forming an adhesive powder in flight as the solvent vaporizes before the spray hits the target and impacting and coating the target in a controlled manner.

The solid particles formed from the liquid droplets in flight are deformable and flatten and stick to the target surface upon impact. If any residual solvent is present, it is quickly eliminated to produce a rigid surface film on the target.

In still another embodiment, the present invention comprises dissolving a dispersant, adhesion promoter, coating polymers and plasticizer in a volatile, non-flammable solvent (such as methylene chloride); and dispersing solid active material particles in the solvent solution with the aid of ultrasonic energy such as a continuous wave ultrasonic bath for 10 minutes.

One advantage of the method is that no heat is needed to cure the applied coating. This facilitates the coating of heat sensitive products and solvent sensitive products and also improves product throughput in manufacturing settings. Additionally, the process does not require the use of high voltage electrical fields, either for atomization or deposition. This also protects sensitive bioagents and electronic products from damage. Further, by adjusting the composition of the polymers, dispersing agents and active particulates in the sprayed liquid, the physical properties of the coating can be tuned to achieve desired characteristics such as the controlled permeability of water and oxygen, the controlled release of active ingredients, mechanical integrity and an aesthetically pleasing surface.

The coating system of the present invention can be used to provide a coating on a wide variety of objects ranging from device surface coatings to fine particulates such as seeds, tablets, granules, beads, powders and crystals as well as article surfaces. For example, the coating methods can also be used in the field of medical devices to provide a coating on a coronary stent for the controlled release of drugs to prevent restinosis. Dielectric coatings can be applied to electrosurgical devices requiring insulation or to coat printed circuit boards in the electronics industry.

In biotechnical or pharmaceutical settings, the coatings can be applied to particles or tablets to produce immediate release, extended release or delayed release characteristics. In an agricultural industry setting, seeds can be coated with a coating containing active particles for the controlled release of fungicides and insecticides. Coatings on seeds can also be applied that will provide a temperature triggered release.

According to one aspect of the invention, a method is provided that combines a dispersant, an adhesion promoter, coating polymers, a plasticizer and active particles in at least one solvent that can be sprayed through the same nozzle to coat a target.

Another aspect of the invention is to provide a method that can modulate the viscosity, particle adhesive properties and active materials with the use of an atomizing nozzle or pressure nozzle.

According to another aspect of the invention, a method for coating is provided that begins with an aerosolized liquid formulation spray that is transformed to deformable solids during flight before hitting the target surface.

Another aspect of the invention is to provide a system with a twin fluid or gas atomizing nozzle that is optionally configured to heat the atomizing gas or air that is delivered through the nozzle to efficiently aid in the evaporation of solvent during flight and avoid the use of heating of the surface of the coating or the ambient atmosphere surrounding the surface, as required in the art.

Another aspect of the invention is to provide a system and method for coating target surfaces with a coating that has characteristic properties that are selected by the user.

Further aspects of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings which are for illustrative purposes only:

FIG. 1 is a flow diagram of a method for a hybrid film coating with an active material according to one embodiment of the invention.

FIG. 2 is a graph of Measured Water Vapor Transmission Rate (G Hr⁻¹ M⁻²) for sprayed 3.7 mil thick polymer film of ethyl cellulose with (TEC) as the plasticizer according to the invention.

FIG. 3 is a graph of Measured Water Vapor Transmission Rate (G Hr⁻¹ M⁻²) for sprayed 3.7 mil thick polymer film of ethyl cellulose with (DBS) as the plasticizer according to the invention.

### DETAILED DESCRIPTION OF THE INVENTION

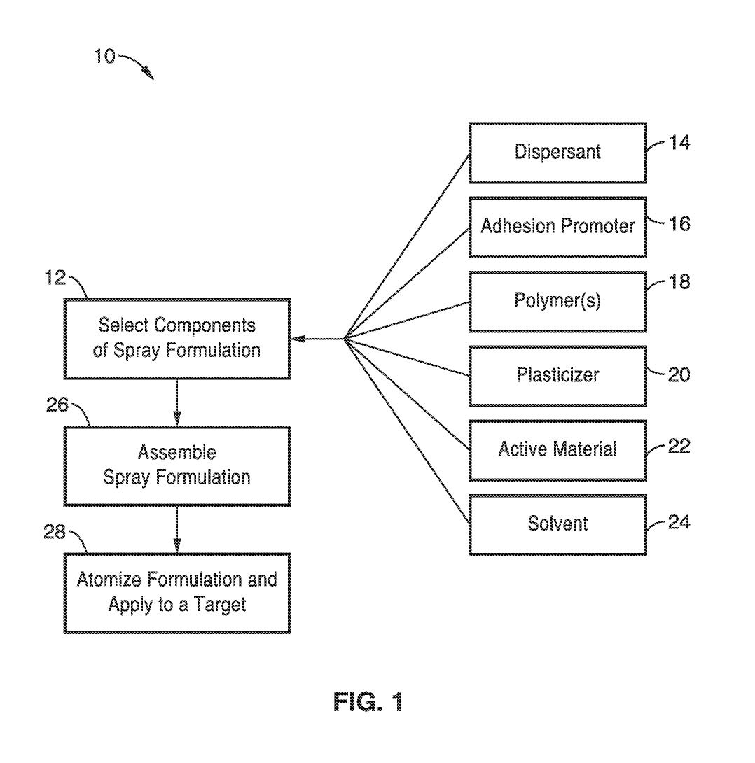

Referring more specifically to the drawings, for illustrative purposes several embodiments of the materials and methods for coating of the present invention are depicted generally in FIG. 1 through FIG. 3. It will be appreciated that the methods may vary as to the specific steps and sequence and the formulations may vary as to structural details, without departing from the basic concepts as disclosed herein. The method steps are merely exemplary of the order that these steps may occur. The steps may occur in any order that is desired, such that it still performs the goals of the claimed invention.

By way of example, and not of limitation, FIG. 1 illustrates schematically one method 10 for coating target surfaces according to the invention. At block 12, the components of the spray formulation are selected. The selection of components at block 12 will be directed by the nature of the surfaces that are to be coated, the desired characteristics of the coating and the intended use of the coated targets. For example, surface sensitivities of the target as well as toxicity, permeability and active material release characteristics can be controlled in part by the selection of components at block 12.

In the embodiment shown in FIG. 1, a dispersant is selected at block 14; an adhesion promoter is selected at block 16; a polymer is selected at block 18; a plasticizer is selected at block 20; at least one active material is selected at block 22 and a solvent is selected at block 24. In another embodiment, the components of the formulation selected at block 12 did not include a plasticizer or a polymer.

The dispersant that is selected at block 14 is preferably an oil soluble material that is capable of dispersing polar particles in the solvent. A dispersant with a low hydrophilic-lipophilic balance (HLB) number (<5) is preferred. Preferred dispersants selected at block 14 include sorbitan monooleate, sorbitan trioleate, alkyl imidazoline and ABA block copolymer where A is poly (12 hydroxy-stearic acid) and B is polyethylene oxide.

The adhesion promoters that are selected at block 16 help to adhere particles to the target substrate after the solvent evaporates in flight. The dispersants listed above are inherently adhesion promoters as well. Therefore, in some settings an additional adhesion promoter may not be necessary. However, if a dispersant selected at block 14 does not promote adhesion, then an adhesion promoter such as paraffin wax (melting point=55° C.) can be selected and used at block 16.

One or more polymers can be selected at block 18 to give further structural integrity and predictable characteristics to the overall coating. For example, polymers can be selected to give extended release characteristics to the coating. Suitable polymers for this purpose include ethyl cellulose, hydroxy propyl methyl cellulose, sodium carboxy methyl cellulose, poly vinyl pyrolidone, vinyl butyral copolymer and low molecular weight polyvinyl chloride.

Other polymers can be selected at block 18 to provide delayed release characteristics to the overall coating. For example, enteric polymers that do not dissolve in the stomach at pH=1.5 but do dissolve in the intestine at pH=5-6 can be selected. Examples of suitable polymers include: cellulose acetate phthalate; methyl acrylic acid copolymers; hydroxy propyl methyl cellulose phthalate and polyvinyl acetate phthalate.

A plasticizer can be selected at block 20 that is generally used to make the polymers less brittle. The plasticizer can also lower the film forming temperature of the polymer. Preferred plasticizers selected at block 20 include: triethyl citrate (TEC); dibutyl sebacate (DBS); dioctyl phthalate (DOP); triacetin and acetylated monoglycerides. If it is desirable to coat particles without polymers, for example, the formulation can be used without the polymer and without the plasticizer.

The selection of an active material at block 22 is governed by the ultimate use of the target and is optional. The active material can be any preferably fine particulate that provides some desirable function to the coating. For example, fungicides, insecticides, fungicides, anti-mold and similar agents can be used in seed coatings. Coatings of medical devices may have drugs that have a desired physiological effect such as drugs to prevent restenosis in coronary stents. However, the active material does not need to be biologically active. The active material could be a colorant such as titanium dioxide, aluminum oxide, zinc oxide or carbon. The selection of the active material will influence the selection of the dispersant and adhesion promoter as well as the polymer.

The selection of the solvent at block 24 is based on boiling point because of the flash evaporation of the solvent aspect of the process. The preferred solvent is methylene chloride. However, other solvents could be used, such as low boiling point cholor-fluoro hydrocarbons where their boiling point is on the order of the boiling point of methylene chloride.

Once the components of the formulation have been selected at block 12, the formulation solution for spraying is assembled at block 26 of FIG. 1. The quantity of each component in the final formulation is also influenced by the ultimate use of the coating and the characteristics of the selected individual components. For example, if the ratio of plasticizer to the other components in the final solution is too large, then the coated particles will stick together and will not disperse. Likewise, if the ratio of polymers to the solvent is too large then the spray solution becomes too viscous and will not spray properly.

Accordingly, at block 26, the spray formulation is assembled with the selected components in the proper proportions. The proportions of each selected component can also be adjusted to optimize the coating procedure and the characteristics of the resulting coating.

The dispersant, adhesion promoter, coating polymers and plasticizer are dissolved in a volatile, non-flammable solvent, preferably methylene chloride, in selected proportions. The preferred ratio of dispersant to active material is within the range of approximately 0.3 to 100 to approximately 3 to 100. The ratio of 1 to 100 of dispersant to active material is particularly preferred.

The ratio of polymer to plasticizer will vary with the selection of polymers and plasticizers. Complete elimination of the plasticizer greatly reduced the quality of the coating and is not preferred. The preferred range of plasticizer to polymer is a ratio of 0.5 to 9.5 to 1 to 3 and the range of 1 to 9 to 1 to 3 is particularly preferred.

The polymer preferably dissolves completely in the solvent. For example, ethyl cellulose will dissolve in methylene chloride but many polymers will not. Some polymers, such as low molecular weight PVC, will only swell in some solvents. The polymer does not have to dissolve so long as it swells to be used in the formulation. However, if the polymer does not dissolve or swell, then a different polymer should be selected to form a coating. A polymer that only disperses in the solvent can be used to modify a coating.

Methylene chloride is the preferred solvent because it is nonflammable and volatile, and has low surface tension so that it is easier to atomize particles. A greater number of smaller particles will yield greater surface area for faster evaporation.

The preferred range of polymer in solvent is approximately 5% to approximately 20%. At 20% polymer in solvent, the solution becomes very viscous. However, the higher viscosity solutions can still be atomized by an air atomization or twin-fluid nozzle.

At block 28 of FIG. 1, the assembled liquid formulation is preferably atomized and applied to a target surface. One important feature of the hybrid coating process of the invention is that it starts with the atomization of a liquid solution/dispersion (like a liquid coating process) and the solvent evaporates without heating during flight producing solid particles that impact, adhere and coat the target so that it ends as a powder coating process. This hybrid process therefore overcomes the inherent difficulties associated with the liquid and powder coating processes and extended heating of the coating is not necessary.

Immediately after the droplets of solvent-component formulation are formed from the nozzle, the solvent evaporates very quickly in flight to produce a much smaller solid particle containing a very high polymer concentration at the surface since the diffusing solvent carries polymer to the surface. This solid particle appears dry, but the core of the particle may still contain trace amounts of solvent since evaporation can be inhibited by the surface polymer membrane. As soon as these deformable particles impact a surface, they flatten and stick. The flattened particle has an increased surface area and shortened diffusion distances and therefore loses any residual solvent very quickly to produce a non-tacky rigid surface film.

This transition from liquid particles to solid particles in flight without heating is accomplished by the contribution of several factors. One factor is the selection of a solvent such as methylene chloride that is highly volatile (Boiling Point=39° C.) and has a very low heat of vaporization (0.089 Kcal/g). Another factor is the inclusion of an adhesion agent (low Hydrophile-Lipophile Balance (HLB) surfactants) in the formulation that aids in adhesion of the solid particles on the target surface.

A further factor may be the use of a gas atomization nozzle that combines high gas flow with low liquid flow that can create very fine liquid particles even with concentrated viscous solutions/dispersions. For example, methylene chloride has a very low surface tension (26.5 dynes/cm at 20° C.) which also promotes the formation of very fine liquid particles with very high surface area resulting in very rapid methylene chloride evaporation.

The gas atomization technique is a highly convective process in which a carrier gas is used to atomize, or create spray droplets from, a bulk of liquid. The liquid flows into the nozzle (either by pumping or a siphon action) where it is mixed with a high velocity jet of carrier gas, the gas then shatters the liquid flow and creates droplets; it also carries the droplets outward in a high speed jet of gas. The advantages of gas atomization include: 1) the ability to atomize highly viscous fluids and slurries, such as a high solid concentration solution or suspension; 2) the ability to use large nozzle openings to prevent clogging; 3) the ability to control spray droplet size independently of liquid flow rate; and 4) the ability to manipulate the relative temperature between the liquid to be atomized and the atomizing and carrier gas supplied to the nozzle.

By manipulating the relative temperature, the rate of vaporization of the liquid solvent can be controlled. For example, supplying heated gas to the gas atomizing nozzle would increase the evaporation rate of the solvent while supplying chilled liquid would decrease the rate of evaporation. Depending on the boiling point of the solvent, the solvent could be kept at a desired temperature below boiling point in order to maintain a concentration or for a safety factor prior to atomization and then the atomizing gas could be heated to a level to cause rapid evaporation.

Finally, by optimizing the distance of the nozzle from the target (effectively, the elapsed time between droplet creation/emission and subsequent impact), complete solvent evaporation occurs before particles impact the target while still allowing maximum capture of particles by the target surface. For pressure nozzles, the pressure determines droplet size and velocity. With gas atomization, the temperature and flow rates of the liquid and gas control the characteristics of the deposit. Accordingly, the atomization pressure can also be optimized.

In another embodiment, the evaporated methylene chloride solvent is captured, condensed and recycled. Compact solvent recovery units are commercially available and could be easily coupled to the spray system.

Accordingly, a powder coating is created as a result of the flash evaporation of the solvent. It is important to note that heat is not required to evaporate the solvent from the surface being coated, so the coating process time is shortened and the coatings can be applied to heat sensitive targets. Furthermore, solvent sensitive target surfaces will not be exposed to solvents since the solvent has evaporated prior to impact of the spray with the surface.

The spray process can also be controlled to prevent any condensation of ambient water or other contaminants in the atmosphere surrounding the target to be coated. By knowing the mass flow rate of solvent through the nozzle and the heat of vaporization of the solvent, the carrier gas supplied to a gas atomizing nozzle can be heated to a sufficient temperature such that no net temperature depression occurs in the coating arena. In essence, the inherent chilling that would occur due to solvent evaporation is offset by a higher temperature (depending on specific heat of the gas, the gas density and gas flow rate). By monitoring the flow rates of the liquid and carrier gas and knowing the heat of vaporization of the solvent and the thermal properties of the gas, the requisite gas temperature can be calculated and an in-line heater used to heat the gas.

The atomization of the formulation at block 28 can be accomplished with hydraulic or pressure nozzles, the energy for atomization (i.e. the creation of droplets from a mass of fluid) is supplied via the liquid to be atomized. The spray characteristics (e.g., flow rate, droplet size, spatial distribution, etc.) are all limited by the geometry of the nozzle and the fluid properties. Gas atomization nozzles are preferred because they can atomize “difficult” fluids such as slurries or suspensions with high solids and are resistive to clogging and wear.

In typical systems, the liquid and gas streams are combined at the nozzle. The air or gas inlet normally has an air shut off valve, air filter and air pressure regulator in the line that is coupled to the nozzle. The liquid inlet typically includes a liquid shut off valve, liquid strainer or filter and liquid pressure regulator in the liquid line coupled to the nozzle. Thus, the gas and liquid flows can be controlled independently. With external mix nozzles, the liquid and gas streams are mixed outside of the nozzle.

In one particularly preferred embodiment, the formulation is atomized at block 28 with a twin fluid gas atomizing system that has temperature control elements in the gas inlet line. The temperature control element allows the inlet gas to be heated to a desired temperature above the ambient temperature. The heated inlet gas flowing out of the nozzle assists in the vaporization of the solvent of the liquid. In another embodiment, the liquid inlet also has a temperature control element that heats or cools the liquid delivered to the nozzle. In this embodiment, the apparatus has a control system that is configured to monitor the temperature of the surface to be coated as well as the in flight spray with a non-contact IR temperature sensor and the temperatures of the carrier gas and the liquid feed are manipulated to maintain a desire temperature. The temperature is an accurate indicator of the degree of solvent evaporation.

Accordingly, in one embodiment, an atomization process is provided that utilizes a gas atomization nozzle in which the liquid to the atomized and the atomizing gas temperatures are manipulated to accelerate or decelerate the evaporation of solvent so as to achieve a desired fraction of solvent remaining on the particles at the time of impact on the target surface. In addition, condensation of ambient liquids in the atmosphere surrounding the deposition target can be prevented by heating the atomization/carrier gas so as to balance the heat of vaporization of the solvent in the spray liquid.

The invention may be better understood with reference to the accompanying examples, which are intended for purposes of illustration only and should not be construed as in any sense limiting the scope of the present invention as defined in the claims appended hereto.

### Example 1

In order to demonstrate the coating process, two types of liquid spray formulations were produced. The first type was a combination of a methylene chloride solvent, a dispersant/adhesion promoter and an engineered particulate with highly specific electrical properties as an active material. The second type of spray formulation was a combination of a dispersant, an adhesion promoter, coating polymers and a plasticizer that were dissolved in methylene chloride and then solid titanium dioxide pigment particles were dispersed in the methylene chloride solution with the aid of ultrasonic energy.

Methylene chloride (BP=39.8° C.) was chosen as the dispersion solvent as it is sufficiently volatile at room temperature so that when sprayed the solvent evaporates prior to the arrival of the other formulation components at the surface of the target and the composite powder is formed in flight.

The spray formulations were delivered through a custom-developed, electrically-neutral, gas atomization and handling system that, in combination with the spray formulation, produced highly mobile, coating particles.

The first type of liquid spray formulation allowed an enclosure containing complex spray targets to be treated nonintrusively from a single entry point and allowed all surfaces within the enclosure to be coated with particles. Surface coating experiments with the first type of liquid spray formulations produced coatings with good adherence even without the polymer which was unexpected. This was accomplished by including a dispersant/adhesive promoter. This coating adhered but could be removed by abrasion.

Trial spray coating experiments using the second type of spray formulation that were conducted using corn seed in a one quart baffled rotating drum resulted in a thin uniform seed coating with respect to polymer and titanium dioxide pigment. The pigment was firmly anchored in the instantly dry polymer coating and hence no fine solid particle lubricant was required. There was no clumping of seeds and there was no dust produced. The process time was very rapid as no time was required for drying.

The applied surface coatings were evaluated for adhesion, agglomeration, and coverage. All of the formulations produced coatings with good adhesion and coverage with little agglomeration. The addition of polymer formed coatings that could not be abraded easily.

### Example 2

In order to apply uniform coatings on a substrate support for mechanical analysis and determination of water vapor transmission rate (WVTR) and oxygen transmission rate (OTR), a rotating drum was utilized. A handheld compressed gas sprayer was modified to produce a narrow fan spray of small volumes of test mixtures and suspensions. A rotating drum was constructed that allowed a substrate material (e.g., vulcanized cotton sheet) to be attached to the drum and treated with the hybrid polymer coatings.

The cardboard drum was 40.6 cm (16 inches) tall and 10.2 cm (4 inches) in diameter. A DC motor was used to rotate the drum. The drum rotational velocity was varied with a DC motor speed controller. The motor was held upright using a ring stand. The driveshaft of the motor was connected to the drum with a threaded rod and a shaft collar. The drum rotation device was placed on the left side of a three meter (nine foot) wide fume hood.

A pressurized sprayer bottle was used that had a maximum volume of 0.946 liters (32 oz). A 40° flat fan nozzle with a flow rate of 64.4 ml min⁻¹ (0.017 GPM) at 275.8 kPa (40 psi) was mounted on the spray bottle. The spray bottle was charged with compressed air to 620.5 kPa (90 psi) giving the spray bottle a flow rate of 96.5 ml min⁻¹ (0.0255 GPM). Samples (200 ml) took on average about 2.5 minutes to spray.

The spray bottle was hand held on the right side of the fume hood 75 cm (29.5 in) away from the rotating drum. The spray bottle was modulated in an up and down sweeping motion. The focus of the spray was at the center of the drum vertically and the modulation was +/−10 cm. All spray trials were conducted at 5 rpm for the drum. This rotational velocity is equivalent to 159.6 cm min⁻¹ (62.8 in min⁻¹). At this rpm, it took 12 seconds for a sprayed location to rotate all the way around and get sprayed again.

The coatings and substrate were removed from the drum and their transmission properties measured. The substrate itself was selected because of its high water vapor transmission rate. Therefore, when the transmission rate of the polymer-coated substrate was measured, the water vapor transmission rate of the polymer film could be determined by subtracting the relatively low barrier properties of the substrate. The thickness of each of the sprayed polymer films was also measured.

### Example 3

The Water Vapor Transmission Rate (WVTR) and Oxygen Transmission Rate (OTR) of polymeric films are important properties for many different applications. However, in order to determine these transport rates, isolated films must be produced. This can often be done by casting solutions of the polymer onto low energy surfaces such as Teflon, allowing the solvent to evaporate and then peeling the intact film off the surface. However, in many cases this technique is not successful either because the polymer film adheres too strongly even on Teflon or the film is too fragile and is shattered in the process of removal.

To avoid these issues, an alternative technique was used. A methylene chloride solution of the polymer was sprayed onto a very thin substrate film where the substrate film has a much higher WVTR or OTR than the applied film and hence the WVTR or OTR of this double layer film really represents the WVTR or OTR of the applied film. Since the solvent evaporates before it reaches the substrate film, the substrate film is not physically compromised. This technique allows the WVTR or OTR of the applied film to be quantitatively measured as a function of film composition. If the WVTR or OTR of the substrate film is only slightly higher or equal to the WVTR or OTR of the applied film, only qualitative rankings of WVTR or OTR can be determined as a function of film composition.

Several different films were produced using different mixtures of polymer, plasticizer and active particle to evaluate the contributions of component concentrations on the WVTR or OTR of the final product. The coatings were deposited on substrates producing composite coating-substrate films using the apparatus described in Example 2. This allowed evaluation of the absolute WVTR for EC coatings as a function of plasticizer and TiO₂ concentrations and the relative OTR for VBCP and PVC coatings as a function of plasticizer concentration.

Films were produced using mixtures of ethyl cellulose, titanium dioxide and a plasticizer (triethyl citrate or dibutyl sebacate). The spray solvent was dichloromethane and spraying was done in a fume hood. The ratios of ethyl cellulose, titanium dioxide and triethyl citrate (TES) or dibutyl sebacate (DBS) were varied over an experimental range and the molecular weight of the ethyl cellulose was varied using commercial products (Ethocel Standards™ 100, 20 and 4; Dow Chemical, Inc.). Water vapor transmission rates were measured using standard methods over a multiday stabilization period.

For WVTR (Water Vapor Transfer Rate) measurements, formulations were made with different ratios of plasticizer to polymer and polymer to active material for evaluation. For example, one formulation was prepared by weighing out 3.52 gm dibutyl sebecate and placing it into 250 ml Pyrex® media bottle. Then 180 ml methylene chloride was added and mixed at high speed until solids were dissolved. Slowly, 10.56 gm Ethocel 4 was added, giving it time to dissolve, and 6 ml of Atlox 4912 in methylene chloride solution (Atlox concentration=0.008 g/ml) was added. Finally, 1.76 gm TiO₂ titanium dioxide was added stirring continuously until it was time to spray. The resulting formulation had a dibutyl sebacate/Ethocel 4 ratio of 1/3 and an Ethocel 4/titanium dioxide ratio of 6/1.

Another formulation was produced having a triethyl citrate/ethyl cellulose 20 ratio of 1/4 and Ethocel 20/titanium dioxide ratio of 6/1. This was produced by weighing out 2.64 gm TEC and introducing it to a 250 ml Pyrex® media bottle. A 180 ml volume of methylene chloride was added and stirred with a stir bar until dissolved for about 20 minutes at 700 rpm. Over a span of 20 minutes, 10.56 gm Ethocel 20 was added slowly until it dissolved followed by the addition of 6 ml Atlox 4912 dispersant in methylene chloride solution (Atlox concentration 0.008 g/ml) and 1.75 gm TiO₂ and stirred until time to spray.

A hard rubber-fiber sheet (5.0 mil thick) known as vulcanized cotton fabric was chosen as the substrate for coating Ethyl cellulose (EC) films because of its low resistance to water vapor (Water absorption equals 63-66%) compared to EC. One of the functions of an EC coating is to act as a water vapor barrier. Therefore, the water vapor transmission rate (WVTR) is an important property of EC coatings.

Various films were created to evaluate the WVTR of the EC films as a function of EC Molecular Weight, plasticizer type (Dibutyl Sebecate (DBS) and Triethyl Citrate (TEC)) and level and TiO₂ particulate level. Four replicates were run for each sample.

The films were measured, cut and preconditioned prior to evaluation. Sections of the films that were free from defects such as cracks or pinholes were cut by gently tapping the top portion of a 4 cm or 6 cm diameter circular die cutter with a mallet for oxygen permeability (OP) or Water Vapor Permeability (WVP) testing, respectively. Preconditioning was performed to standardize all samples prior to subjecting them to oxygen and moisture permeability tests according to the Standard method, D 618-00 (2000), due to the fact that the barrier properties may be affected by relative humidity and temperature. An environmental chamber at 50±5% RH over a saturated solution of magnesium nitrate, Mg(NO₃)₂.6H₂O was placed in a 23±2° C. controlled temperature room. The samples were preconditioned by keeping them in the chamber at least for 48 hours before the tests. In order to prevent interactions of the samples, smooth-surfaced release papers with a silicone finish were used to place the samples in the environmental chamber in accordance with ASTM D2370-98 (2010).

Film thickness was measured by a caliper micrometer to the nearest 25 μm at four and five random positions on each testing specimen used for OP and WVP tests, respectively. Mean thickness values for each sample were calculated and used in oxygen transmission rate (OTR) and water vapor transmission rate (WVTR) calculations.

### Example 4

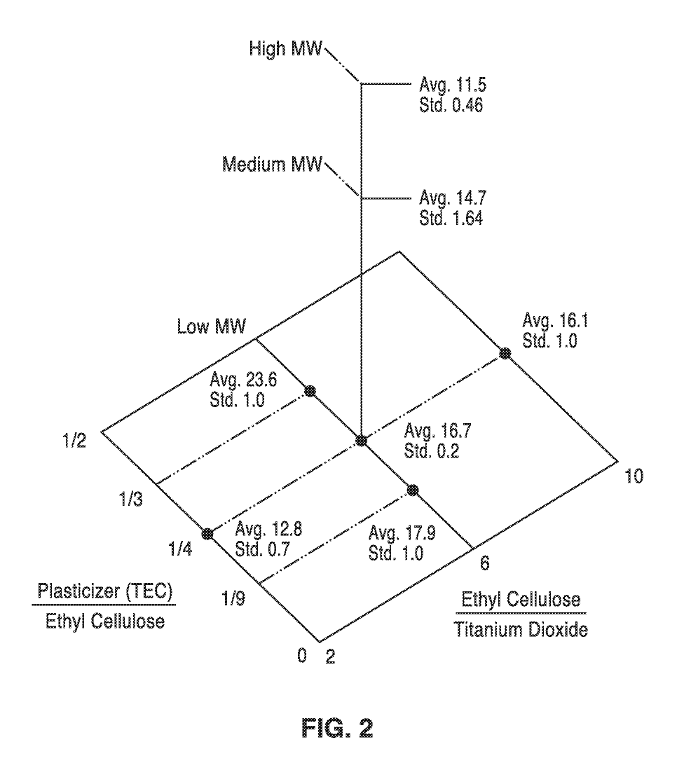

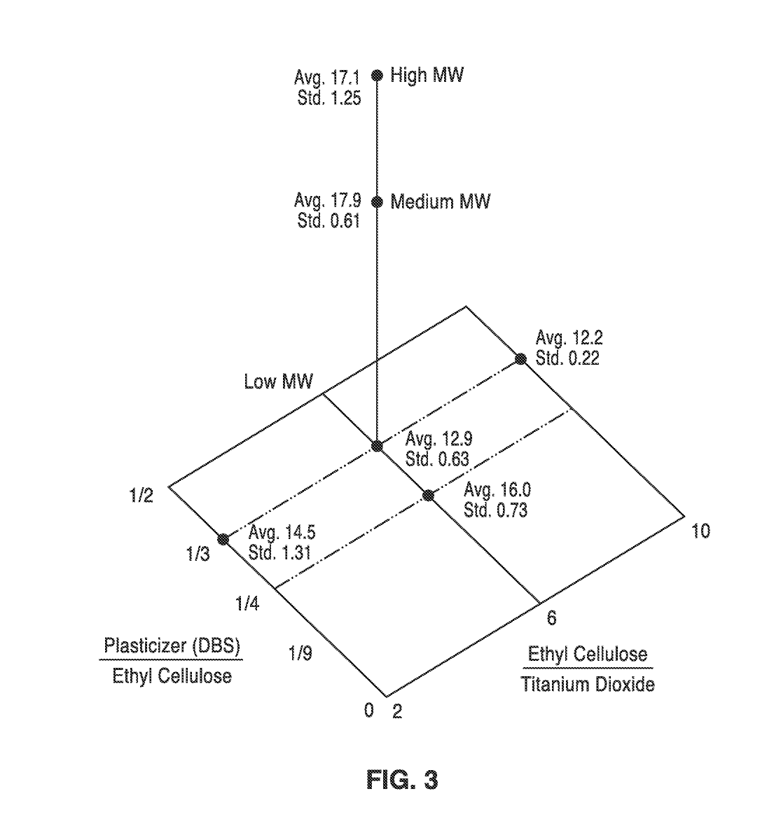

Prepared samples of the various films were tested for water vapor permeability. The water vapor transmission rate for a 3.7 mil thick low, medium and high molecular weight ethyl cellulose films with varying ratios of TEC/EC and EC/TiO₂ is shown in FIG. 2. The water vapor transmission rate for a 3.7 mil thick low, medium and high molecular weight ethyl cellulose films with varying ratios of DBS/EC and EC/TiO₂ is shown in FIG. 3. In addition, the vertices of the plane shown in FIG. 2 and FIG. 3 are ratios of plasticizer to ethyl cellulose on one edge and the ratio of ethyl cellulose to active particles on the other.

Water vapor transmission rate (WVTR) was determined in accordance with the WVP modified cup method correcting for the resistance of the stagnant air gap in the test cups. It was assumed that the relative humidity under the sample was 100%, however, the % RH is less than 100% since there is a stagnant air layer just below the sample surface. Therefore, the calculations that were used account for the stagnant layer.

The sprayed and non-sprayed samples were mounted on plexiglass plastic cups with wide rims containing 6 grams of distilled water. The samples were then sealed on the cups with plastic rings that were screwed into the cup rim with aid of silicone high vacuum grease as a sealant. The spray-coated sides of the samples were facing the high RH environment (facing down) in all experiments consistently.

After taking the initial weight of the test cups, the cups were placed in an environmental chamber at 0% RH and 23±2° C. For the 0% RH condition in the environmental chamber, anhydrous calcium sulfate desiccant was placed into trays and then the trays were immediately placed into the chamber. In order to check that the chamber was at 0% RH, a hygrometer probe was placed into the chamber and % RH in the chamber was monitored. A fan was used in the chamber to ensure uniform % RH over the surface of the samples at a velocity of more than 152 m/min. The cups were weighed at certain intervals after steady state was achieved to measure water vapor lost though the samples from the cups. A linear regression analysis of water weight loss versus time was performed to obtain WVTR of the samples. Then, WVP was calculated from WVTR by the equation: WVP=WVTR×thickness/water vapor partial pressure (where WVTR is in g h⁻¹ m⁻², thickness is in millimeters and partial pressure is in kilopascals). Four replicates of each sample were evaluated.

The WVTR results shown graphically in FIG. 2 and FIG. 3 are average value with standard deviation and have been normalized to 3.7 mils. For example, in FIG. 2 the Medium MW EC film with TEC/EC=1/4 and EC/TiO₂=6/1 had a thickness of 4.5 mil. The WVTR for this 4.5 mil coating was 12.1 g/hr-m² that was normalized to 3.7 mil. Therefore, the WVTR for this coating reported in FIG. 2 was based on the calculations: (3.7 mil)=12.1(4.5/3.7)=14.7 g/hr-m² with Standard Deviation=1.64.

Similarly, the WVTR and associated standard deviations shown in FIG. 3 for films with the DBS plasticizer were also normalized to 3.7 mils, For example, the Low MW EC film with DBS/EC=1/3 and EC/TiO₂=6/1 was 4.0 mil thick. The observed WVTR for this coating was (4.0 mil)=11.9 g/hr-m². Therefore, the WVTR for the coating was normalized to 3.7 mil and plotted in FIG. 3. The reported WVTR for the 4.0 mil coating was (4.0)=11.9 (4.0/3.7)=12.9 g/hr-m². Standard Deviation=0.585(4.0/3.7)=0.63.

The results shown in FIG. 2 and FIG. 3 clearly show that the water vapor transmission rates can be adjusted over a 2:1 range (from 11.5 to 23.6 g hr⁻¹ m⁻²) through the manipulation of the spray properties and that continuous films can be produced by the spray methods.

As shown in the TEC plasticizer results in FIG. 2, when the ratio of plasticizer to Low MW EC (1/4) is constant, the WVTR values increased as the TiO₂ was reduced with respect to the Low MW EC. This indicated that the TiO₂ had greater water vapor transmission resistance than the plasticized (TEC) EC coating.

It can also be seen in the results of FIG. 2 that when the ratio of polymer/active particles (e.g. Low MW EC to TiO₂ at 6/1) is held constant, the WVTR increases as the plasticizer ratio was increased. This result can be explained by the fact that TEC has appreciable water solubility (65 grams/liter). In addition, at a constant ratio of plasticizer to EC (e.g. 1/4) and constant ratio of EC to TiO₂ (e.g. 6/1), the WVTR is reduced as the molecular weight (MW) of the EC increases.

By comparison, it can be seen in the DBS plasticizer results in FIG. 3 that when the ratio of plasticizer to Low MW EC (e.g. 1/3) is held constant, the WVTR decreases as the TiO₂ is reduced with respect to Low MW ethyl cellulose polymer. This indicated that the TiO₂ had less water vapor transmission resistance than the plasticized (DBS) EC coating.

FIG. 3 also shows that at a constant ratio of Low MW EC to TiO₂ (e.g. 6/1), the WVTR decreased as the plasticizer quantity increases. This result can be explained based on the fact that DBS has very low water solubility (0.04 grams/liter) and hence water has very low solubility in DBS.

It can also be seen in FIG. 3 that when that ratio of plasticizer to EC (e.g. 1/3) and the ratio of EC to TiO₂ (e.g. 6/1) are constant, the WVTR increases as the molecular weight of the EC polymer increases.

### Example 5

In order to evaluate oxygen permeability, coatings formed from different formulations were created. In addition to ethyl cellulose coatings, formulations using other polymers and plasticizers were produced both with and without active materials. To illustrate permeability characteristics of coatings without active materials, formulations with vinyl butyral copolymer (VBCP) and low molecular weight PVC (LMWPVC) were assembled and sprayed. Formulations using different percentages of Triethyl Citrate (TEC) and different percentages of Dioctyl Phthalate (DOP) with the VBCP and LMWPVC polymers were evaluated for oxygen transmission rate (OTR).

For example, a vinyl butyral copolymer with 25% DOP formulation was produced by placing 21 grams of copolymer in a 500 ml media bottle and adding 400 ml of methylene chloride and stirring with stir bar. Then 7 grams of DOP (dioctyl phthalate) was added slowly and stirred until the Copolymer is dissolved.

Similarly, a vinyl butyral copolymer with 12.5% TEC formulation was produced by placing 21 grams of copolymer in a 500 ml media bottle and adding 400 ml of methylene chloride and stirring with stir bar. Then 3 grams of triethyl citrate (TEC) was added slowly and stirred until the Copolymer is dissolved and stirred continuously until it was time to spray. All the other Samples were prepared using the same procedures.

A Low Density Polyethylene (LDPE) (0.6 mil thick) was chosen as the substrate for coating Vinyl Butyral Copolymer (VBCP) and Low MW PVC (LMWPVC) because its resistance to oxygen was the same order of magnitude as that of VBCP and LMWPVC. Even though the absolute value of OTR for these plasticized polymer coatings could not be evaluated from the OTR of the composite films, the trends in OTR as plasticizer level was varied could be determined.

Oxygen transmission rate (OTR) is a procedure for determining steady-state rate of transmission of oxygen gas through the samples. The OTR characteristics of the coatings were measured with an Ox-Tran 2/20 ML modular system in accordance with ASTM standard method D 3985-95 (1995).

The sprayed film samples were preconditioned at 23±2° C. and 50±5% RH for a minimum of 48 hours and were double-masked with strong adhesive aluminum foil tapes leaving a circular uncovered testing area of 0.42 cm². Then, the films were sealed in the Oxtran test cells. The test cells were sealed to prevent outside air from entering by the use of rubber O-rings and the application of Apiezon type T vacuum grease to the metal surfaces, O-rings and foil masks. The films were masked and placed between stainless steel plates. The outer half of the test cell (one side of the film) was purged by flowing 100% oxygen and the inner half of the test cell (another side of the film) was purged by flowing carrier gas, which consist of 98% nitrogen and 2% hydrogen. Oxygen molecules diffusing through the films to the inner side of the test cell were conveyed to the sensor by the carrier gas. The sprayed side of the films was faced with oxygen gas in the test cells. OP was calculated by multiplying OTR (cm³ m⁻² day⁻¹) by the average film thickness (μm) and dividing by partial pressure of O₂ at 100% oxygen (kPa). Four replicates were made for each sample formulation.

The OTR of the prepared VBCP coatings were evaluated as a function of plasticizer type and concentration. The relative OTR for VBCP composite coatings were normalized to 3.1 mil thickness. For example, the TEC/VBCP=1/3 composite coating thickness was 3.1 mil. The OTR for this coating was (3.1 mil)=513.5 cm³/m²-day with a standard deviation=29.9.

The OTR results for the TEC/VBCP formulations showed a minimal resistance to oxygen at 6.25% TEC. The coating with 12.5% TEC had an OTR of 387.5 (24.4) and the 25.0% TEC coating had an OTC of 513.5 (29.9). The 37.5% TEC formulation produced a sticky film with an OTC of 596.6 (27.2).

The coatings from the DOP/VBCP formulations had OTC that were similar. The 12.5% DOP coating had an OTC of 502.6 (18.8). The 25.0% DOP coating had an OTC of 398.3 (13.5) and the 37.5% DOP coating had an OTC of 599.6 (34.6).

For the VBCP-TEC coating system, the 12.5% TEC coating gives the greatest oxygen resistance and for the VBCP-DOP coating system, 25.0% DOP gives the greatest oxygen resistance. For both plasticizers, the 37.5% formulation produced sticky coatings. For the 6.25% TEC, there was minimal oxygen resistance.

The OTR of the prepared LMWPVC coatings were also evaluated as a function of plasticizer type and concentration. The relative OTR for the PVC composite coatings were also normalized to a 3.1 mil thickness. For example, the DOP/PVC=1/3 composite coating thickness was 7.0 mil. The OTR for this coating normalized to (3.1 mil)=226.6 (7.0/3.1)=511.7 cm³/m²-day with a standard deviation=51.5.

The PVC did not completely dissolve in methylene chloride containing the DOP plasticizer; however the PVC did swell in the methylene chloride containing DOP plasticizer. The spray was a dispersion rather than a solution. However a uniform coating was achieved nevertheless.

The 12.5% DOP/PVC composite coating normalized to 3.1 mil had an OTC of 502.5 (18.8). The 25.0% DOP/PVC coating had an OTC of 511.7 (51.5). The 37.5% DOP/PVC coating had an OTC of 763.3 (12.4) and the 50.0% DOP/PVC coating had an OTC of 1284.7 (92.3). For the PVC-DOP system, 12.5% DOP gives the greatest oxygen resistance and the 6.25% DOP/PVC showed minimal resistance to oxygen.

From the discussion above it will be appreciated that the invention can be embodied in various ways, including the following:

1. A method for coating a surface, comprising: preparing a liquid formulation of a volatile solvent, a dispersant, and adhesion promoter and particulates of an active material; aerosolizing said liquid formulation into droplets; and volatilizing said solvent from said droplets during delivery to a target surface.

2. A method as recited in the previous embodiment, wherein the solvent comprises methylene chloride.

3. A method as recited in any of the previous embodiments, wherein the dispersant is selected from the group of dispersants consisting of sorbitan monooleate, sorbitan trioleate, alkyl imidazoline and ABA block copolymer where A is poly(12 hydroxy-stearic acid) and B is polyethylene oxide.

4. A method as recited in any of the previous embodiments, wherein the dispersant also functions as an adhesion promoter; wherein a separate adhesion promoter in the formulation is not needed.

5. A method as recited in any of the previous embodiments, wherein the active material is selected from the group of active materials consisting of a drug, an insecticide, a fertilizer, a fungicide and a pigment.

6. A method as recited in any of the previous embodiments, further comprising adding at least one polymer and at least one plasticizer to the liquid formulation.

7. A method as recited in any of the previous embodiments, wherein the polymer is selected from the group of polymers consisting of ethyl cellulose, hydroxy propyl methyl cellulose, sodium carboxy methyl cellulose, poly vinyl pyrolidone, vinyl butyral copolymer and low molecular weight polyvinyl chloride.

8. A method as recited in any of the previous embodiments, wherein the polymer is selected from the group of polymers consisting of cellulose acetate phthalate, methyl acrylic acid copolymers, hydroxy propyl methyl cellulose phthalate and polyvinyl acetate phthalate.

9. A method as recited in any of the previous embodiments, wherein the plasticizer is selected from the group of plasticizers consisting of triethyl citrate (TEC), dibutyl sebacate (DBS), dioctyl phthalate (DOP), triacetin and acetylated monoglycerides.

10. A coating method, comprising: spraying a liquid formulation of at least one polymer and at least one plasticizer dissolved/dispersed in a highly volatile, nonflammable solvent; vaporizing solvent from the spray to form deformable solid particles in flight; and impacting and coating the target with the deformable particles.

11. A method as recited in any of the previous embodiments, wherein the solvent comprises methylene chloride.

12. A method as recited in any of the previous embodiments, wherein the polymer is selected from the group of polymers consisting of ethyl cellulose, hydroxy propyl methyl cellulose, sodium carboxy methyl cellulose, poly vinyl pyrolidone, vinyl butyral copolymer and low molecular weight polyvinyl chloride.

13. A method as recited in any of the previous embodiments, wherein the polymer is selected from the group of polymers consisting of cellulose acetate phthalate, methyl acrylic acid copolymers, hydroxy propyl methyl cellulose phthalate and polyvinyl acetate phthalate.

14. A method as recited in any of the previous embodiments, wherein the plasticizer is selected from the group of plasticizers consisting of triethyl citrate (TEC), dibutyl sebacate (DBS), dioctyl phthalate (DOP), triacetin and acetylated monoglycerides.

15. A method as recited in any of the previous embodiments, further comprising adding at least one dispersant and at least one active material to the liquid formulation.

16. A method as recited in any of the previous embodiments, further comprising adding at least one adhesion promoter to the liquid formulation.

17. A method for coating a surface, comprising: preparing a liquid formulation of a volatile solvent, a dispersant, an adhesion promoter, a polymer, a plasticizer and particulates of an active material; aerosolizing the liquid formulation into droplets with a gas atomization nozzle operably coupled to a gas source and a liquid source; controlling the temperature of the gas source; vaporizing solvent from said droplets to form deformable solid particles in flight; and impacting and coating the target with the deformable particles; wherein gas temperatures are manipulated to accelerate or decelerate the evaporation of solvent on the particles in flight to the target.

18. A method as recited in any of the previous embodiments, further comprising: controlling liquid formulation temperature.

19. A method as recited in any of the previous embodiments, wherein the ratio of dispersant to active material is within the range of 0.3 to 100 to 3 to 100.

20. A method as recited in any of the previous embodiments, wherein the ratio of plasticizer to polymer is within the range of 0.5 to 9.5 to 1 to 3.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

In the claims, reference to an element in the singular is not intended to mean “one and only one” unless explicitly so stated, but rather “one or more.” All structural, chemical, and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A method for coating a surface, comprising:
preparing a liquid formulation of a volatile solvent, a dispersant, and an adhesion promoter and particulates of an active material;
aerosolizing said liquid formulation into droplets; and
volatilizing said solvent from said droplets during delivery to a target surface.

2. A method as recited in claim 1, wherein said solvent comprises methylene chloride.

3. A method as recited in claim 1, wherein said dispersant is selected from a group of dispersants consisting of sorbitan monooleate, sorbitan trioleate, alkyl imidazoline and ABA block copolymer where A is poly(12 hydroxy-stearic acid) and B is polyethylene oxide.

4. A method as recited in claim 1, wherein said dispersant also functions as he/said adhesion promoter; wherein a separate adhesion promoter in the formulation is not needed.

5. A method as recited in claim 1, wherein said active material is selected from the group of active materials consisting of a drug, an insecticide, a fertilizer, a fungicide and a pigment.

6. A method as recited in claim 1, further comprising adding at least one polymer and at least one plasticizer to said liquid formulation.

7. A method as recited in claim 6, wherein said polymer is selected from the group of polymers consisting of ethyl cellulose, hydroxy propyl methyl cellulose, sodium carboxy methyl cellulose, poly vinyl pyrolidone, vinyl butyral copolymer and low molecular weight polyvinyl chloride.

8. A method as recited in claim 6, wherein said polymer is selected from the group of polymers consisting of cellulose acetate phthalate, methyl acrylic acid copolymers, hydroxy propyl methyl cellulose phthalate and polyvinyl acetate phthalate.

9. A method as recited in claim 6, wherein said plasticizer is selected from the group of plasticizers consisting of triethyl citrate (TEC), dibutyl sebacate (DBS), dioctyl phthalate (DOP), triacetin and acetylated monoglycerides.

10. A coating method, comprising:
spraying a liquid formulation of at least one polymer and at least one plasticizer dissolved/dispersed in a highly volatile, nonflammable solvent;
vaporizing solvent from said spray to form deformable solid particles in flight; and
impacting and coating the target with said deformable particles.

11. A method as recited in claim 10, wherein said solvent comprises methylene chloride.

12. A method as recited in claim 10, wherein said polymer is selected from the group of polymers consisting of ethyl cellulose, hydroxy propyl methyl cellulose, sodium carboxy methyl cellulose, poly vinyl pyrolidone, vinyl butyral copolymer and low molecular weight polyvinyl chloride.

13. A method as recited in claim 10, wherein said polymer is selected from the group of polymers consisting of cellulose acetate phthalate, methyl acrylic acid copolymers, hydroxy propyl methyl cellulose phthalate and polyvinyl acetate phthalate.

14. A method as recited in claim 10, wherein said plasticizer is selected from the group of plasticizers consisting of triethyl citrate (TEC), dibutyl sebacate (DBS), dioctyl phthalate (DOP), triacetin and acetylated monoglycerides.

15. A method as recited in claim 10, further comprising adding at least one dispersant and at least one active material to said liquid formulation.

16. A method as recited in claim 15, further comprising adding at least one adhesion promoter to said liquid formulation.

17. A method for coating a surface, comprising:
preparing a liquid formulation of a volatile solvent, a dispersant, and adhesion promoter, a polymer, a plasticizer and particulates of an active material;
aerosolizing said liquid formulation into droplets with a gas atomization nozzle operably coupled to a gas source and a liquid source;
controlling the temperature of said gas source;
vaporizing solvent from said droplets to form deformable solid particles in flight; and
impacting and coating the target with said deformable particles;
wherein gas temperatures are manipulated to accelerate or decelerate the evaporation of solvent on the particles in flight to the target.

18. A method as recited in claim 17, further comprising controlling liquid formulation temperature.

19. A method as recited in claim 17, wherein the ratio of dispersant to active material is within the range of 0.3 to 100 to 3 to 100.

20. A method as recited in claim 17, wherein the ratio of plasticizer to polymer is within the range of 0.5 to 9.5 to 1 to 3.
